(19) United States
(12) Patent Application Publication
(10) Pub. No.: US 2025/0175502 A1
(43) Pub. Date: May 29, 2025

(54) Enabling UDP/TCP Encapsulation in Baseband

(71) Applicant: Apple Inc., CUPERTINO, CA (US)

(72) Inventors: Amit DUBEY, San Diego, CA (US); Bobby JOSE, San Diego, CA (US); Darshan Bharat ASHAR, San Jose, CA (US); Krisztian KISS, Rancho Santa Fe, CA (US); Sudeep MANITHARA VAMANAN, Uttenreuth (DE); Vijay VENKATARAMAN, San Jose, CA (US); Vinay Rajkumar PATIL, San Jose, CA (US); Vivek G GUPTA, San Jose, CA (US)

(21) Appl. No.: 18/958,145

(22) Filed: Nov. 25, 2024

Related U.S. Application Data
(60) Provisional application No. 63/603,219, filed on Nov. 28, 2023.

(51) Int. Cl. H04L 9/40; H04W 28/02

(52) U.S. Cl. CPC H04L 63/20; H04W 28/0268

(57) ABSTRACT

An apparatus configured to negotiate with an Internet Security Protocol (IPSec) host device to determine whether both a user equipment (UE) and the IPsec host device are capable of supporting synchronization of IPSec information and when both the UE and the IPsec host device are capable of supporting synchronization of IPSec information, receive IPSec information from the IPSec host device over a dedicated channel, the IPSec information being configured to support encapsulation.

### PRIORITY/INCORPORATION BY REFERENCE

This application claims priority to U.S. Provisional Application Ser. No. 63/603,219 filed on Nov. 28, 2023, entitled “Enabling UDP/TCP Encapsulation in Baseband,” the entirety of which is incorporated by reference herein.

### BACKGROUND

A user equipment (UE) architecture may include terminal equipment (TE) and mobile termination (MT) functions interfaced by a terminal adapter (TA). An attention (AT) command may be sent by the TE to the TA and be used to control MT behavior. In telecommunications and signal processing, baseband signals (i.e., the range of frequencies occupied by a signal that has not been modulated to higher frequencies such as radio frequency (RF)) may be transmitted. Encapsulation (i.e., concatenating layer specific headers or trailers with a service data unit (a payload)) is often used for transmitting information over computer networks. It has been identified that there is a need for efficient methods to enable encapsulation, and in particular, Transmission Control Protocol/User Datagram Protocol (TCP/UDP) encapsulation such that higher data rates may be realized.

### SUMMARY

Some example embodiments are related to an apparatus having processing circuitry configured to negotiate with an Internet Security Protocol (IPSec) host device to determine whether both a user equipment (UE) and the IPsec host device are capable of supporting synchronization of IPSec information and, when both the UE and the IPsec host device are capable of supporting synchronization of IPSec information, receive IPSec information from the IPSec host device over a dedicated channel, the IPSec information being configured to support encapsulation.

Other example embodiments are related to an apparatus having processing circuitry configured to negotiate with an Internet Security Protocol (IPSec) host device to determine whether both a user equipment (UE) and the IPsec host device are capable of supporting synchronization of IPSec information, when both the UE and the IPsec host device are capable of supporting synchronization of IPSec information and at least one valid UDP/TCP encapsulation rule has been received from a network, initiate a fetch of the IPSec information from the IPSec host device upon detection of a first downlink (DL) Security Protocol Index (SPI) over a data path, upon detecting any new unknown DL SPI, transmit a request to the IPSec host device to provide uplink and downlink SPI (UL/DL SPI) and receive updated IPSec information comprising the UL/DL SPI from the IPSec host device.

### BRIEF DESCRIPTION OF THE DRAWINGS

FIG. 1 shows an example architecture according to various example embodiments.

FIG. 2 shows an example network arrangement according to various example embodiments.

FIG. 3 shows an example UE according to various example embodiments.

FIG. 4 shows an example architecture for a device to exchange information with an Internet Security Protocol (IPSec) host according to various example embodiments.

FIG. 5 shows an example device according to various example embodiments.

FIG. 6 shows an example call flow diagram according to various example embodiments.

FIG. 7 is an example call flow diagram illustrating an example interactive method for requesting and receiving IPsec information to and from an IPsec host and a device according to various example embodiments.

FIG. 8 is an example call flow diagram illustrating an example polling method for requesting and receiving IPsec information to and from an IPsec host and a device according to various example embodiments.

FIG. 9 shows an example flow diagram for filtering encapsulated data according to various example embodiments.

### DETAILED DESCRIPTION

The example embodiments may be further understood with reference to the following description and the related appended drawings, wherein like elements are provided with the same reference numerals. The example embodiments introduce methods and devices to enable UDP/TCP encapsulation in baseband. In particular, the example embodiments introduce methods to allow a device to communicate with and exchange Internet Protocol Security (IPsec) information with an IPsec host to retrieve IPsec security associations (SAs) for UDP encapsulation.

The example embodiments are described with regard to an example user equipment (UE) architecture comprising a terminal equipment (TE) and mobile termination (or mobile terminal) (MT) functions interfaced by a terminal adaptor (TA) on the network side. The TE may be any external or peripheral component or device communicatively coupled to a baseband (BB) component of a device, such as a laptop or personal computer, an AT command terminal, or an external access point. An AT command may be sent by the TE to the TA. The AT command may be utilized as an internal interface within the UE (e.g., between the application layer and the radio interface layer). However, reference to a UE is merely provided for illustrative purposes. The example embodiments may be utilized with any electronic component that is configured with the hardware, software, and/or firmware to implement this type of example architecture and perform 5G NR Quality of Experience (QoE) measurements.

In the below description, various information elements (IEs) and parameters have been referred to by a name. These names are only examples and the IEs and parameters may be referred to by other names or no names at all.

Before discussing the proposed methods and devices to enable encapsulation, and in particular, Transmission Control Protocol/User Datagram Protocol (TCP/UDP) encapsulation, such that higher data rates can be realized, an example UE architecture is discussed.

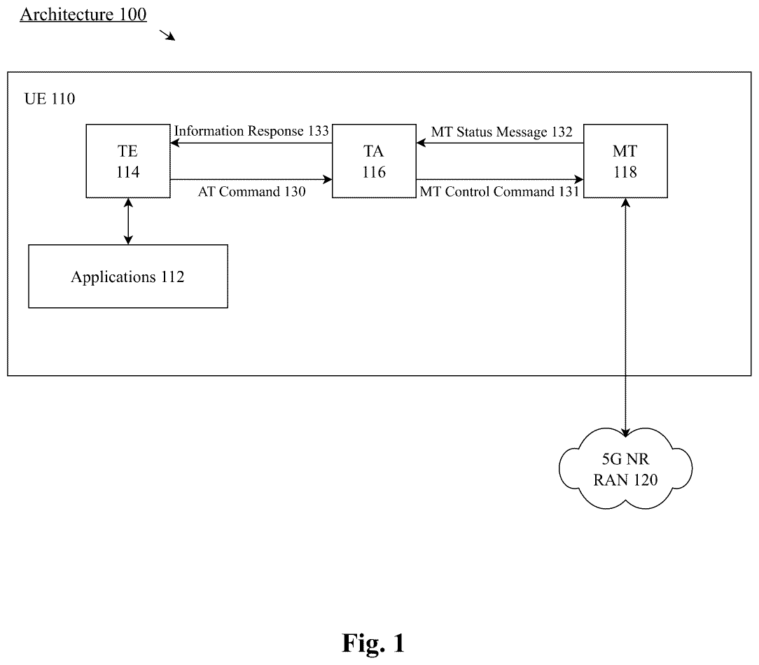

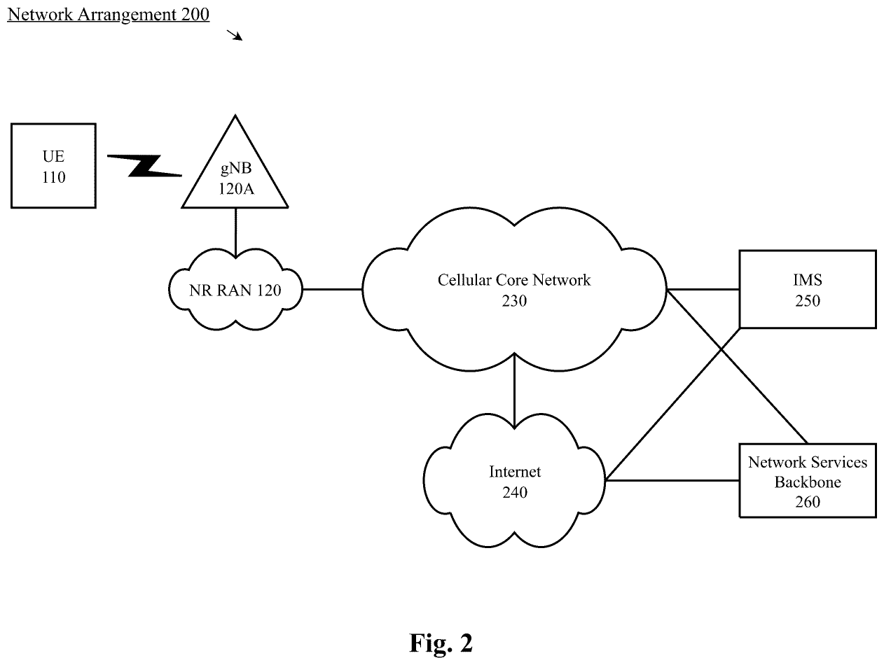

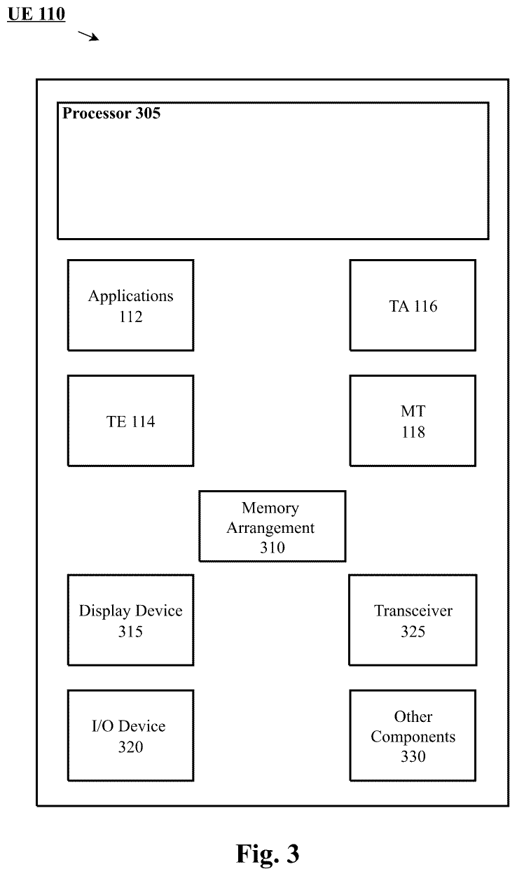

FIG. 1 shows an example architecture 100 according to various example embodiments. The example UE architecture 100 may include one or more applications 112 executed by an application processor or any appropriate type of processing circuitry of the UE 110. Additional details regarding the UE 110, the NG RAN 120 and an example network arrangement are provided below with regard to FIGS. 2-3.

In addition, the example architecture 100 includes a UE architecture comprising a TE 114, a TA 116 and a MT 118. The MT 118 may send and receive messages from one or more networks. In this example, the network is a next generation (NG) radio access network (RAN) 120. While the example embodiments may be used to support QoE management in a NG RAN, the example embodiments are not limited to this type of network and may apply to any appropriate type of network.

The TE 114 may be communicatively coupled to the MT 118 via the TA 116. In some embodiments, the TE 114 may be executed by the application processor of the UE 110 and the MT 118 may be executed by the baseband processor of the UE 110. However, the example embodiments are not limited to this arrangement of processors and entities, the example architecture 100 may be implemented using any appropriate type of processing component or circuitry (e.g., application, baseband, etc.) and any appropriate number of entities. For instance, in some examples, the TE 114, the MT 118 and the TA 116 may be implemented as a single entity or three separate entities. In other examples, the TA 116 may be integrated under the MT 118 and the TE 114 may be implemented as a separate entity or the TA 116 may be integrated under the TE 114 and the MT 118 may be implemented as a separate entity.

During operation, the one or more applications 112 running on the UE 110 may be configured to perform various operations for 5G QoE management. Accordingly, the one or more applications 112 may transmit signals to the TE 114 indicating, for example, a value of an application layer 5G QoE measurement parameter or a request to read a 5G QoE measurement configuration. In response, the TE 114 may generate and transmit an AT command 130 to the TA 116. The AT command 130 may be processed by the TA 116 and then an MT control command 131 or any other appropriate type of message may be sent to the MT 118.

The AT command may be utilized as an internal interface within the UE 110 between the application layer and the radio interface layer. The AT command may be configured to control the behavior of the MT 118. For example, an AT command may be used to configure the manner in which the TE 114 is to receive configuration information from the network via the MT 118. In another example, the AT command may be used to set the parameters the MT 118 is to send to the network (e.g., NR RAN 120) in an application layer measurement report. However, these AT commands are merely provided for illustrative purposes and are not intended to limit the example embodiments in any way. These examples are provided as a general overview of the types of interactions that may occur between the TE 114, the TA 116 and the MT 118.

The MT 118 may send an MT status message 132 to the TA 116. The contents of the MT status message may be based on the command 130. For example, the AT command 130 may configure the MT 118 to perform a particular operation in response to an event. When the event occurs, the MT 118 may be triggered to send the MT status message to the TA 116 comprising data related to the previously received AT command 130. In other examples, the MT status message 132 may include data indicating an intermediate status of a task or operation to be performed in response to the AT command 130 or may include a data indication that a task or operation to be performed in response to the AT command 130 is complete.

The TA 116 may send an information response 133 comprising a result code. The result code may be characterized as a final result code sent in response to an AT command, an intermediate result code configured to inform the TE 114 of the process of TA operation or an unsolicited result code configured to indicate the occurrence of an event not directly associated with issuance of an AT command. These examples are provided as a general overview of the types of messages that may be sent to the TE 114 by the TA 116.

FIG. 2 shows an example network arrangement 200 according to various example embodiments. The example network arrangement 200 includes a UE 110. The UE 110 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network architecture 100, the network with which the UE 110 may wirelessly communicate is a NG RAN 120. The UE 110 may also communicate with other types of networks (e.g., 5G RAN, 5G cloud RAN, LTE RAN, a legacy cellular network, a wireless local area network (WLAN), etc.) and the UE 110 may also communicate with networks over a wired connection. Therefore, the UE 110 may have a 5G chipset to communicate with the NG RAN 120 and, optionally, any other appropriate type of chipset to communicate with other types of networks.

The NG RAN 120 may be a portion of a cellular network that may be deployed by a network carrier (e.g., Verizon, AT&T, T-Mobile, etc.). The NG RAN 120 may include cells and base stations that are configured to send and receive traffic from UEs that are equipped with the appropriate cellular chip set. In this example, the NG RAN 120 includes the gNB 120A. However, reference to a gNB is merely provided for illustrative purposes, the example embodiments may be utilized with any appropriate type of access node may be (e.g., Node Bs, eNodeBs, HeNBs, eNBs, gNBs, gNodeBs, macrocells, microcells, small cells, femtocells, etc.).

Any association procedure may be performed for the UE 110 to connect to the NG RAN 120. For example, the NG RAN 120 may be associated with a particular network carrier where the UE 110 and/or the user thereof has a contract and credential information (e.g., stored on a SIM card). Upon detecting the presence of the NG RAN 120, the UE 110 may transmit the corresponding credential information to associate with the NG RAN 120. More specifically, the UE 110 may associate with a base station, e.g., the gNB 120A).

The network arrangement 200 also includes a cellular core network 230, the Internet 240, an IP Multimedia Subsystem (IMS) 250, and a network services backbone 260. The cellular core network 230 may refer an interconnected set of components that manages the operation and traffic of the cellular network. The cellular core network 230 also manages the traffic that flows between the cellular network and the Internet 240. The IMS 250 may be generally described as an architecture for delivering multimedia services to the UE 110 using the IP protocol. The IMS 250 may communicate with the cellular core network 230 and the Internet 240 to provide the multimedia services to the UE 110. The network services backbone 260 is in communication either directly or indirectly with the Internet 240 and the cellular core network 230. The network services backbone 260 may be generally described as a set of components (e.g., servers, network storage arrangements, etc.) that implement a suite of services that may be used to extend the functionalities of the UE 110 in communication with the various networks.

FIG. 3 shows an example UE 110 according to various example embodiments. The UE 110 will be described with regard to the network architecture 100 of FIG. 1. The UE 110 may include a processor 305, a memory arrangement 310, a display device 315, an input/output (I/O) device 320, a transceiver 325 and other components 330. The other components 330 may be, for example, an audio input device, an audio output device, a power supply, a data acquisition device, ports to electrically connect the UE 110 to other electronic devices, etc.

The processor 305 may be configured to execute one or more applications for the UE 110 and the UE entities described above in the example architecture 100, e.g., TE 114, AT 116 and MT 118.

The above referenced one or more applications 112 and UE entities being executed by the processor 305 is merely provided for illustrative purposes. The functionality associated with the one or more applications 112 and each of the TE 114, AT 116, MT 118 may also be represented as separate incorporated components of the UE 110 or may be a modular component coupled to the UE 110, e.g., an integrated circuit with or without firmware. For example, the integrated circuit may include input circuitry to receive signals and processing circuitry to process the signals and other information. In addition, in some UEs, the functionality described for the processor 305 is split among two or more processors such as a baseband processor and an applications processor. The example embodiments may be implemented in any of these or other configurations of a UE.

The memory arrangement 310 may be a hardware component configured to store data related to operations performed by the UE 110. The display device 315 may be a hardware component configured to show data to a user while the I/O device 320 may be a hardware component that enables the user to enter inputs. The display device 315 and the I/O device 320 may be separate components or integrated together such as a touchscreen.

The transceiver 325 may be a hardware component configured to establish a connection with the NG RAN 120, an LTE-RAN (not pictured), a legacy RAN (not pictured), a WLAN (not pictured), etc. Accordingly, the transceiver 325 may operate on a variety of different frequencies or channels (e.g., set of consecutive frequencies). In one example embodiment, the transceiver 325 may include circuitry configured to transmit and/or receive signals (e.g., control signals, data signals). Such signals may be encoded with information implementing any one of the methods described herein. The processor 305 may be operably coupled to the transceiver 325 and configured to receive from and/or transmit signals to the transceiver 325. The processor 305 may be configured to encode, decode and/or process signals (e.g., signaling from a base station of a network) for implementing any one of the methods described herein.

Internet Protocol Security (IPsec) refers to a secure network protocol suite that authenticates and encrypts packets of data to provide secure encrypted communication between two computers or other communication devices over an Internet Protocol network. It may be used for various purposes in various networks, such as in virtual private networks (VPNs). IPSec User Datagram Protocol (UDP) encapsulation is one type of encapsulation. When building an ESP (Encapsulating Security Payload) packet, it can be further encapsulated by placing a UDP header in front of the ESP header. This is known as UDP encapsulation, e.g., IPSec over NAT (network address translation). The packet format may be:
[IP HDR|TCP/UDP HDR|ESP/AH HDR|DATA]

The relevant 3 GPP standards and in particular, 3GPP TS 24.501, discuss two ways to perform IPSec UDP encapsulation. The first is by signaling, such as Non-Access-Stratum (NAS) signaled QOS (Quality of Service), where the network can set both SPI (Security Protocol Index) and PORTs with next header protocol as UDP/TCP for TCP/UDP encapsulation filters. The UE expects an uplink (UL) SPI in the QOS filter received from the network and the same could be used for UL packet comparison.

### Packet Filter Component Type Identifier Bits

| 8 | 7 | 6 | 5 | 4 | 3 | 2 | 1 | |
|---|---|---|---|---|---|---|---|---|
| 0 | 0 | 1 | 1 | 0 | 0 | 0 | 0 | Protocol ID/Next header type |
| 0 | 1 | 0 | 0 | 0 | 0 | 0 | 0 | Single local port type |
| 0 | 1 | 0 | 0 | 0 | 0 | 0 | 1 | Local port range type |
| 0 | 1 | 0 | 1 | 0 | 0 | 0 | 0 | Single remote port type |
| 0 | 1 | 0 | 1 | 0 | 0 | 0 | 1 | Remote port range type |
| 0 | 1 | 1 | 0 | 0 | 0 | 0 | 0 | Security parameter index type |

The second discussed in TS 24.501 is by data path, through the use of reflective QOS (RQOS) filters, where the ROOS is derived from downlink (DL) packets. Hence, the modem gets DL SPI from the DL packets. Thus, the network can provide the DL SPI in the DL packet. However, the UL SPI is not provided.

There are some basic problems with these two approaches. First, the standard (TS 24.501) does not define the UE behavior to retrieve UL and DL SPI mapping for TCP/UDP encapsulation support. Second, encapsulation using these techniques needs multi-level transport header IP packet deep inspection, and executing multi-level packet filtering on each packet degrades data rates. The standard does not provide a method by which the UL SPI is populated from the IPsec host to the device to have the encapsulation feature work from end to end. Thus, there is a need to obtain the UL SPI from the IPSec host and provide it to the device. The IPSec information, including the UP SPI, is configured to work end to end. That is, the IPsec information allows the encapsulation to be good from the sender to the recipient (i.e., all the way from the IP host to a remote IPSec server), such that any entity in the middle (such as the device) that forwards the data onward cannot decrypt the encapsulated data. Only the application layer (and not the device) knows about the IPsec information such as the SPI and/or encryption/decryption keys.

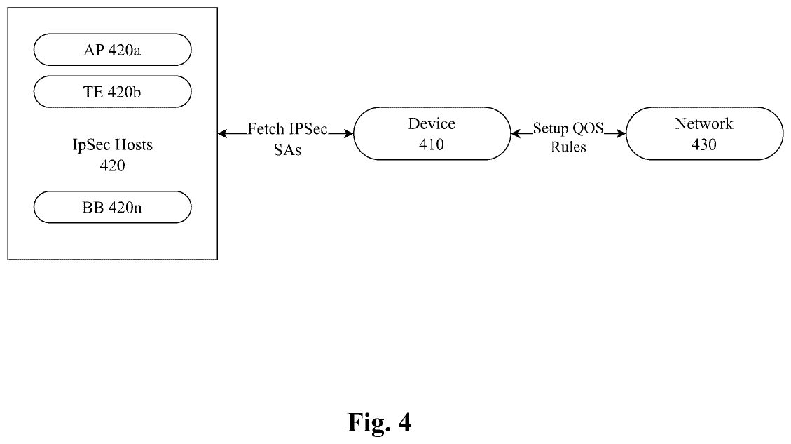

FIG. 4 shows an example architecture 400 according to various example embodiments. Device 410 may interact or interface with or more IP hosts 420a-420n and a network 430. Device 410 may be a device. Device 410 may be a baseband processor. Device 410 may be a modem. To provide efficient encapsulation, such as TCP/UDP encapsulation, in baseband, it is proposed that the device 410 will hand-shake with one or more of the IPSec hosts 420a-420n to retrieve IPSec SAS (security associations, e.g., endpoints) for UDP encapsulation. The IPSec hosts 420a-420n may include any entity who sets up and/or manages IPSec SAs. Example IP hosts may include an applications processor (AP) 420a, terminal equipment (TE) 420b, and/or baseband equipment (BB) 420n. Both the IPSec hosts 420a-420n and the device 410 may maintain a database of IPSec information, which may include security associations, UL and DL SPI, IPSec encapsulation rules, and/or other information related to encapsulation, such as encryption/decryption keys. The device 410 can interface with multiple IPSec hosts at the same time. The device 410 may interact with a network 430 to receive QOS rules via NAS signaling or via Reflective QOS. The device 410 will administer and control the interface(s) with the IPSec hosts 420a-420n.

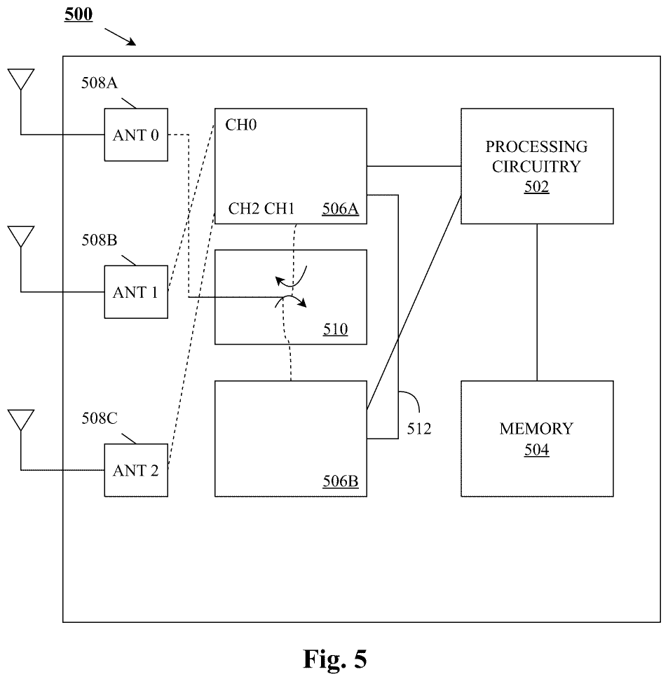

FIG. 5 shows an example device 500 according to various example embodiments. The device 500 may be a baseband device. The baseband device 500 includes a processing circuitry 502, which may include baseband processing circuitry, and a memory 504, or other non-transitory computer-readable storage media. The memory 504 may include, for example, SRAM, FLASH, SDRAM, and/or HDD (Hard Disk Drive) components. The device 500 may further include one or more wireless interfaces 506. A wireless interface may be a modem (e.g., cellular modem, Bluetooth (BT) modem, WiFi modem). For example, in one example implementation, the device 500 may include a WLAN baseband modem 506A (compliant with IEEE 802.11 wireless standards, e.g., Wi-Fi) and a Bluetooth (BT) baseband modem 506B. The WLAN interface (CH0, CH1, CH2) may have two (2) antenna interfaces 508B (ANT1), 508C (ANT2) and may share an antenna interfaces 508A (ANT0) with the BT interface via a switch element 510. During certain operational modes, the WLAN and BT interfaces may “time share” the shared antenna interfaces. Specifically, WLAN/BT time sharing algorithms allocate a first portion of time to the BT interface, and a second portion of time to the WLAN interface.

In some example embodiments, the one or more wireless interfaces are configured to negotiate with one another to determine the highest priority wireless interface. In one configuration, the WLAN baseband 506A coordinates priorities between itself and the BT baseband 506B via a bus interface 512. Common examples of a bus interface include for example: address and data busses, serial interfaces, parallel interfaces, etc. Specifically, in one example variant, the bus interface enables a data transfer between the WLAN baseband and the BT baseband.

In some example embodiments, the UE 110 shown in FIGS. 1-3 may include the functionality of the device 500.

Methods and devices are hereby proposed to enable encapsulation, and in particular, Transmission Control Protocol/User Datagram Protocol (TCP/UDP) encapsulation, for communication involving devices, such that higher data rates can be realized

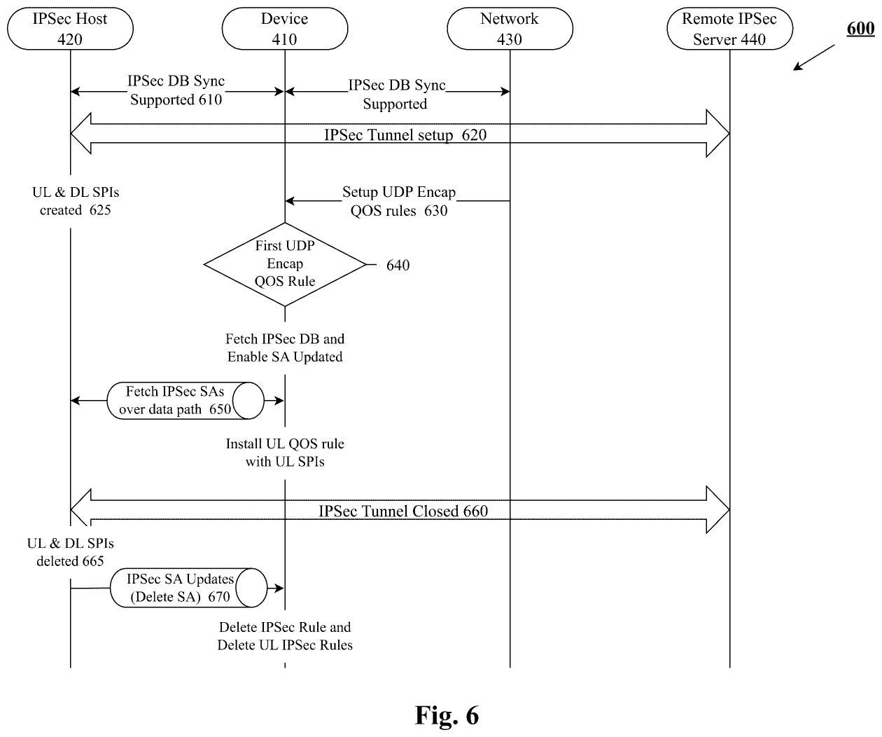

FIG. 6 shows an example call flow diagram 600 according to various example embodiments. In particular, in FIG. 6, at boot up time or at call setup time, the device 410 will negotiate with the IPSec host 420 and/or the network 430 to see if IPsec synchronization and exchange of IPSec information (IPsec DB Sync) is supported, and in particular if UDP encapsulation is supported (610). If the negotiation is successful, then only the device 410 will receive the IPSec information from the network; otherwise, the device 410 will not receive the IPSec information. Further, for additional negotiation or to get the IPSec information or security associations, there will be a dedicated hardware channel set up between the IPSec host 420 and a remote IPSec server 440 (620). In one embodiment, the dedicated channel may be an IPSec Tunnel. The dedicated channel helps achieve higher data rates because exchanging the security associations over the control path is slow, and as a result, packets may get dropped.

The IPsec host 420 creates the UL and DL SPIs (625). Upon receiving a first QOS UDP encapsulation rule setup from the network (630), the device 410 will start fetching information from the IPSec database (DB) of the IPSec host device so that the IPSec information, including SAs, may be obtained and/or updated (640). The IPSec SAs may be fetched from the IPSec host 420 over a data path in one embodiment (650). In this manner, the device 500 may acquire (and/or exchange) the IPSec information from the IPSec host 420, including the UL QOS rules with the UL SPI, over the dedicated channel. The IPsec tunnel may be closed at this time in one embodiment (660). In other embodiments, the IPSec tunnel may remain open. The IPsec host 420 may delete the UL and DL SPIs in some embodiments (665). The IPsec host 420 may also update the IPSec SAs and may forward the SA updates to the device 410 (670). The previous SA may be deleted in some embodiments, and an update indicating such can be sent to the device 410. The device 410 may delete and/or update the IPSec rule(s) and may delete and/or update the UL IPSec rules based on the information received from the IPSec host 420. The AP or other IPSec host 420, or the device 410, may keep updating the IPSec DB in favorable conditions for existing and new rules via interactive, polling or hybrid method, as discussed in more detail below.

The current 3GPP Specification (TS 24.501) does not provide any mechanism where the network is aware of UDP/TCP baseband encapsulation support or not. The network may assume that encapsulation is supported and will generate rules for encapsulation. In the absence of UDP/TCP encapsulation capability, the network may generate encapsulation rules and schedule UDP/TCP encapsulated filters, which might result in the waste of resources as the UE cannot filter the UL packets without having the UL SPI. Accordingly, the network and the UE can be out of sync as the network would assume packets to be routed correctly, when in fact they have not been routed correctly. Given the method disclosed above in FIGS. 4 and 6, the AP or other IPSec host and the device will negotiate IPSec DB sync capability at boot up time or at the time of call setup, and the device will fetch IPSec SAs after successful capability negotiation. The device will then communicate the IPSec information to the network to enable UDP encapsulation.

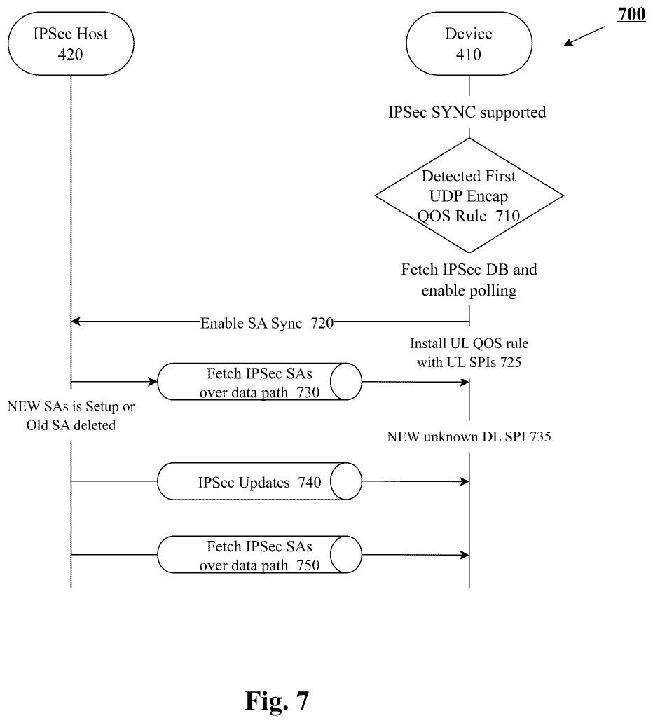

FIG. 7 is an example call flow diagram illustrating an example interactive method 700 for requesting and receiving IPsec information to and from an IPsec host 420 and a device 410. Assuming that IPSec SYNC is supported by the device 410 and the IPSec host 420, when a valid UDP/TCP encapsulation rule is detected by the device 410 from a network (710), the device 410 will enable requesting and receiving new IPSEC SA updates from the AP or other IPSec host 420 (720). The device 410 may install an UL QOS rule with UL SPIs that it has received from the network (725).

As long as the device 410 has at least one valid UDP/TCP encapsulation rule, the device 410 will check for updates from the IPSec host 420. If the IPSec host 420 sets up one or more SA(s) or deletes one or more old SA(s), the device 410 will fetch one or more IPSec SAs from the IPSec host upon detecting a first DL SPI over a data path (730). The device 410 will request the AP or other IPSec host 420 to provide a UL/DL SPI upon detecting any new unknown DL SPI (735). In one embodiment, the IPSec Host will report immediately any IPSec updates (new SA creation or old SA deletions) (740). Upon receiving the indication from the IPSec host that there are IPSec SA updates, the device 410 may fetch any new IPSec SAs over a data path between the device 410 and the IPsec host 420 (750). In this manner, both the device 410 and the IPSec host 420 will notify each other whenever new or updated encapsulation rules are being set up, pr when any encapsulation rules have been deleted. In one embodiment, the device 410 may disable requesting and receiving new IPSEC SA updates from the AP or other IPSec host 420 when the device 410 has no IPSec QOS rules.

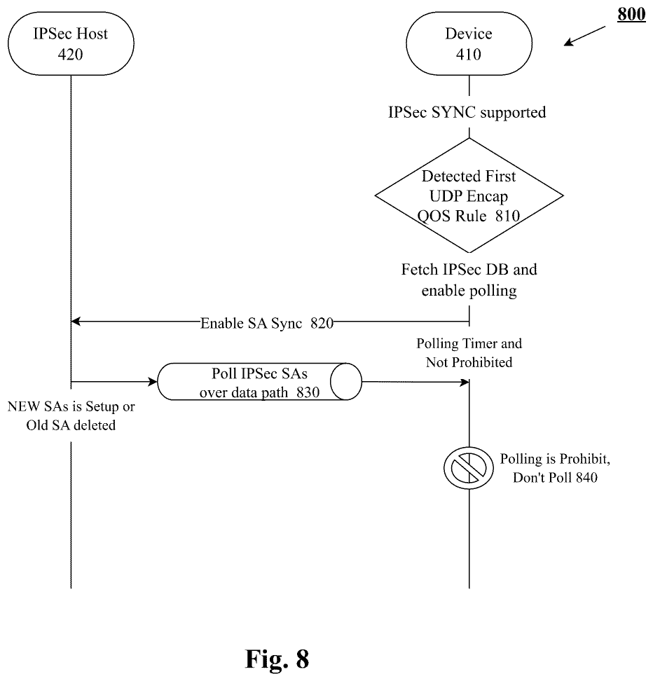

FIG. 8 is an example call flow diagram illustrating an example polling method 800 for requesting and receiving IPsec information to and from an IPsec host 420 and a device 410. The device 410 can choose to enable polling the IPsec host IPSEC SAs. The device 410 will be running a timer with a predefined time period. When the timer expires, the device 410 will poll the IPSec host 420 for the IPSec DB to see if there are any new encapsulation rules or if any rules have been deleted.

In one embodiment, assuming that IPSec SYNC is supported by the device 400 and the IPSec host 420, when a valid UDP/TCP encapsulation rule is detected by the device 410 from a network (810), the device 410 may enable SA SYNC by fetching the IPSec DB and enabling polling (820). The device 410 may periodically poll for UL/DL IPSec DB (UL and DL SPIs) (830), such as over a data path between the device 410 and the IPSec host 420. That is, the device 410 may poll once per time period. In some embodiments, a polling timer may be based on the data rate, such as the uplink throughput (UL Tput). For example, a higher UL Tput will have a lower polling value; that is, the polling will occur more often. A higher UL Tput may also have a lower polling timeout. As long as the polling timer is enabled and polling is not prohibited, the device 410 will continue to periodically poll the IPsec host 420 for IPSec information. If there are IPSec updates (a new SA is set up or an old SA is deleted), the IPsec host 420 will return the updated IPSec information to the device 410.

In some embodiments, the device 410 may change the polling timer or polling period, or the device 410 may even prohibit polling (840). For example, if the AP is in power save or sleep mode, or is in RRC (Radio Resource Control) IDLE/inactive mode (i.e., no data call is set up), or there is a long CDRX (Connected Mode Discontinuous Reception (DRX)) period, the device 410 may change the polling timer or polling period, or the device 410 may even prohibit polling in order to avoid wasting resources and or draining power.

Thus, the device may use either the interactive method shown in FIG. 7 or the polling method shown in FIG. 8 to obtain and/or exchange IPSec information from the IPSec host 420. In other embodiments, the device may use both the interactive and the polling method, or may use a hybrid of the two methods.

The device 410 may also maintain the IPSec DB per PDN (Packet Data Network) connection. In addition, the device 410 may clear the IPSec DB upon the last rule deletion or when the associated PDN is torn down. Further, the device 410 may install UL filter(s) with the UL SPI(s) once the network has set up the QOS/ROOS filter(s).

In order to implement the above discussed functionality, an AT command interface may be defined to access and validate modem functionality. Whenever the device detects a new IPSec rule, the device may send a notification or unsolicited result code to the IPSec host. This may be done via a proprietary messaging system, or via an AT command like is being proposed herein. Certifications (e.g., GCF, Lab) use AT commands for conformance. A new AT command AT+ENCAP is proposed to negotiate UDP/TCP encapsulation capability: AT+ENCAP=<Capability>, where if the Capability value is 0, TCP/UDP encapsulation is disabled, and if the Capability is 1, TCP/UDP encapsulation is enabled. The modem will set a result OK upon successful execution, otherwise an error is indicated. A DL SPI notification/Unsolicited Result code +ENCAP may also be used, where +ENCAP: <New DL SPI>. The device will send the URC (Unsolicited result code) to the TE upon receiving a new DL SPI when TCP/UDP capability is enabled.

Table 1 below shows a possible +ENCAP parameter command syntax.

TABLE 1
+ENCAP parameter command syntax

| Command | Possible response |
|---|---|
| +ENCAP=<capability> | OK |
| | +CME ERROR: <err> |
| +ENCAP? | 1 : Enabled |
| | 0 : Disabled |
| +ENCAP=? | +ENCAP: [0,1] |

The device and the IPSec host may build up an interface based on an application programming interface (API) Method—called with in a processor—or via ICC (Inter process communication) between the device and an AP processor to exchange IPSec SAs in the below IPSec SA format, where CID is a channel identifier:
CID/APN NAME/PDU SESSION ID
UL SPI
DL SPI
Mode—Add/Delete

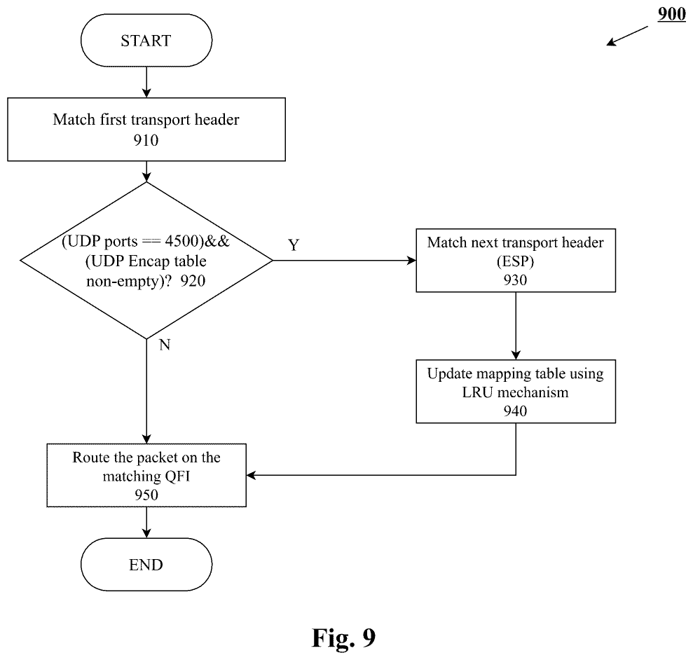

In addition to the exchange of IPSec information between the device and the IPSec host, filtering of the encapsulated data may be optimized as well so that the device can efficiently send the data to the appropriate PDN or bearer. Given an encapsulated packet with multiple headers, such as in the format [IP HDR|TCP/UDP HDR|ESP/AH HDR|DATA], the outer transport headers can be used for filtering. FIG. 9 shows an example flow diagram for filtering according to various example embodiments. The process 900 starts and a first outer transport header (e.g., the TCP/UDP header) may be matched to the database (910). As per RFC 3948, UDP Encapsulation of IPSec ESP Packets uses port number=4500. While running the UL filtering logic, this may be used to optimize the filtering process, i.e., check for the second transport header only if the UDP port=4500 and the UDP Encapsulation Table is non-empty. That is, in 920 of the filtering process, a check is made and if the UDP port=4500 and the UDP Encapsulation Table is non-empty, then a match of the next transport header is attempted (930) and if a match is found, the mapping table is updated (940). The rationale here takes advantage of the likelihood of consecutive packets matching the same filter, and thereby uses a LRU (Least Recently Used) mechanism to optimize the look-ups and re-arrange the UDP Encapsulation table. The entry corresponding to the last packet seen would be moved to the top of the UDP Encapsulation table, and for the next packet, this would then become the first look-up that would be looked at for a match. If the UDP port does not =4500 and/or the UDP Encapsulation Table is empty, then the packet is routed on the matching QFI (950).

### Examples

In a first example, a method, comprising negotiating with an Internet Security Protocol (IPSec) host device to determine whether both the UE and the IPsec host device are capable of supporting synchronization of IPSec information and, when both the UE and the IPsec host device are capable of supporting synchronization of IPSec information, receive IPSec information from the IPSec host device over a dedicated channel, the IPSec information being configured to support encapsulation.

In a second example, the method of the first example, further comprising initiating a fetch of the IPSec information from the IPSec host device upon receipt of a quality of service (QOS) encapsulation rule from a network.

In a third example, the method of the second example, wherein the IPSec information from the IPSec host device comprises IPSec security associations (SAs).

In a fourth example, the method of the second example, wherein the IPSec information from the IPSec host device comprises an uplink (UL) Security Protocol Index (SPI) created by the IPSec host device.

In a fifth example, the method of the fourth example, further comprising implementing the QOS encapsulation rule with the UL SPI.

In a sixth example, the method of the first example, wherein the dedicated channel is an IPsec tunnel.

In a seventh example, the method of the first example, further comprising receiving updates of IPSec information from the IPSec host device.

In an eighth example, the method of the seventh example, wherein the updates of the IPSec information comprises a deletion of an uplink (UL) Security Protocol Index (SPI) previously created by the IPSec host device.

In a ninth example, the method of the first example, further comprising negotiating with an additional Internet Security Protocol (IPSec) host device to determine whether both the UE and the IPsec host device are capable of supporting synchronization of IPSec information and, when both the UE and the additional IPsec host device are capable of supporting synchronization of IPSec information, receiving additional IPSec information from the additional IPSec host device, and interfacing with the IPSec host device and the additional IPSec host device at the same time.

In a tenth example, the method of the first example, further comprising transmitting the IPSec information received from the IPSec host device to a network to enable the network to provide UDP/TCP encapsulation rules.

In an eleventh example, the method of the first example, wherein upon receipt of a quality of service (Qos) encapsulation rule from a network, the method further comprising periodically polling the IPSec host device for the IPSec information.

In a twelfth example, the method of the eleventh example, wherein the IPSec information comprises uplink (UL) and downlink (DL) Security Protocol Index (SPI) information.

In a thirteenth example, the method of the eleventh example, further comprising polling the IPSec host device for the IPSec formation upon expiration of a polling timer having a predetermined time period.

In a fourteenth example, the method of the thirteenth example, wherein the predetermined time period for the polling timer is based on an uplink (UL) throughput, the predetermined time period being shorter the higher the UL throughput is.

In a fifteenth example, the method of the eleventh example, further comprising prohibiting the periodic polling when the IPSec host device is in power save or sleep mode, or is in RRC (Radio Resource Control) IDLE/inactive mode, and/or there is a long CDRX (Connected Mode Discontinuous Reception (DRX) period.

In a sixteenth example, the method of the first example, further comprising maintaining a database with the IPSec information.

In a seventeenth example, the method of the fourth example, further comprising implementing uplink filtering with the UL SPI.

In an eighteenth example, the method of the first example, further comprising receiving an encapsulated packet with multiple headers, including a TCP/UDP header and an ESP header, matching the TCP/UDP header to a corresponding entry in a database, determining whether UDP encapsulation of the packet is enabled by checking to see if a UDP port=4500 and a UDP Encapsulation Table is non-empty, when the UDP port=4500 and the UDP Encapsulation Table is non-empty, attempting a match of the ESP header in the database, and when a match of the ESP header is found, updating a mapping table using a Least Recently Used (LRU) mechanism.

In a nineteenth example, the method of the first example, further comprising sending a notification or unsolicited result code to the IPSec host device when a new downlink (DL) Security Protocol Index (SPI) is received as part of the IPSec information.

In a twentieth example, the method of the first example, further comprising sending an attention (AT) command to the IPSec host device to negotiate UDP/TCP encapsulation capability, wherein the AT command has the format: AT+ENCAP=<Capability>, where if the Capability value is 0, TCP/UDP encapsulation is disabled, and if the Capability is 1, TCP/UDP encapsulation is enabled.

In a twenty first example, a processor configured to perform any of the methods of the first through twentieth examples.

In a twenty second example, a user equipment (UE) configured to perform any of the methods of the first through twentieth examples.

In a twenty third example, a method, comprising negotiating with an Internet Security Protocol (IPSec) host device to determine whether both the UE and the IPsec host device are capable of supporting synchronization of IPSec information and, when both the UE and the IPsec host device are capable of supporting synchronization of IPSec information and at least one valid UDP/TCP encapsulation rule has been received from a network, initiating a fetch of the IPSec information from the IPSec host device upon detection of a first downlink (DL) Security Protocol Index (SPI) over a data path, upon detecting any new unknown DL SPI, transmitting a request to the IPSec host device to provide uplink and downlink SPI (UL/DL SPI) and receiving updated IPSec information comprising the UL/DL SPI from the IPSec host device.

In a twenty fourth example, the method of the twenty third example, further comprising receiving an indication from the IPSec host device immediately upon the IPSec host device creating a new security association (SA) and/or deleting an old SA.

In a twenty fifth example, the method of the twenty third example, further comprising disabling requesting and receiving IPSec information from the IPSec host device when the UE has no valid UDP/TCP encapsulation rules.

In a twenty sixth example, a processor configured to perform any of the methods of the twenty third through twenty fifth examples.

In a twenty seventh example, a user equipment (UE) configured to perform any of the methods of the twenty third through twenty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
negotiate with an Internet Security Protocol (IPSec) host device to determine whether both a user equipment (UE) and the IPsec host device are capable of supporting synchronization of IPSec information; and
when both the UE and the IPsec host device are capable of supporting synchronization of IPSec information, receive IPSec information from the IPSec host device over a dedicated channel, the IPSec information being configured to support encapsulation.

2. The apparatus of claim 1, wherein the processing circuitry is further configured to initiate a fetch of the IPSec information from the IPSec host device upon receipt of a quality of service (QOS) encapsulation rule from a network.

3. The apparatus of claim 2, wherein the IPSec information from the IPSec host device comprises IPSec security associations (SAs).

4. The apparatus of claim 2, wherein the IPSec information from the IPSec host device comprises an uplink (UL) Security Protocol Index (SPI) created by the IPSec host device.

5. The apparatus of claim 4, wherein the processing circuitry is further configured to implement the QOS encapsulation rule with the UL SPI.

6. The apparatus of claim 1, wherein the dedicated channel is an IPsec tunnel.

7. The apparatus of claim 1, wherein the processing circuitry is further configured to receive updates of IPSec information from the IPSec host device, wherein the updates of the IPSec information comprises a deletion of an uplink (UL) Security Protocol Index (SPI) previously created by the IPSec host device.

8. The apparatus of claim 1, wherein the processing circuitry is further configured to:
negotiate with an additional Internet Security Protocol (IPSec) host device to determine whether both the UE and the IPsec host device are capable of supporting synchronization of IPSec information; and
when both the UE and the additional IPsec host device are capable of supporting synchronization of IPSec information, receive additional IPSec information from the additional IPSec host device,
wherein the processing circuitry is configured to interface with the IPSec host device and the additional IPSec host device at the same time.

9. The apparatus of claim 1, wherein upon receipt of a quality of service (QOS) encapsulation rule from a network, the processing circuitry is further configured to periodically poll the IPSec host device for the IPSec information.

10. The apparatus of claim 9, wherein the IPSec information comprises uplink (UL) and downlink (DL) Security Protocol Index (SPI) information.

11. The apparatus of claim 10, wherein the processing circuitry is further configured to poll the IPSec host device for the IPSec formation upon expiration of a polling timer having a predetermined time period.

12. The apparatus of claim 11, wherein the predetermined time period for the polling timer is based on an uplink (UL) throughput, the predetermined time period being shorter the higher the UL throughput is.

13. The apparatus of claim 9, wherein the processing circuitry is further configured to prohibit the periodic polling when the IPSec host device is in power save or sleep mode, or is in RRC (Radio Resource Control) IDLE/inactive mode, and/or there is a long CDRX (Connected Mode Discontinuous Reception (DRX) period.

14. The apparatus of claim 1, wherein the processing circuitry is further configured to maintain a database with the IPSec information.

15. The apparatus of claim 1, wherein the processing circuitry is further configured to:
receive an encapsulated packet with multiple headers, including a TCP/UDP header and an ESP header;
match the TCP/UDP header to a corresponding entry in a database;
determine whether UDP encapsulation of the packet is enabled by checking to see if a UDP port=4500 and a UDP Encapsulation Table is non-empty;
when the UDP port=4500 and the UDP Encapsulation Table is non-empty, attempting a match of the ESP header in the database;
when a match of the ESP header is found, update a mapping table using a Least Recently Used (LRU) mechanism.

16. The apparatus of claim 1, wherein the processing circuitry is further configured to send a notification or unsolicited result code to the IPSec host device when a new downlink (DL) Security Protocol Index (SPI) is received as part of the IPSec information.

17. The apparatus of claim 1, wherein the processing circuitry is further configured to send an attention (AT) command to the IPSec host device to negotiate UDP/TCP encapsulation capability, wherein the AT command has the format: AT+ENCAP=<Capability>, where, when the Capability value is 0, TCP/UDP encapsulation is disabled, and when the Capability is 1, TCP/UDP encapsulation is enabled.

18. An apparatus comprising processing circuitry configured to:
negotiate with an Internet Security Protocol (IPSec) host device to determine whether both a user equipment (UE) and the IPsec host device are capable of supporting synchronization of IPSec information;
when both the UE and the IPsec host device are capable of supporting synchronization of IPSec information and at least one valid UDP/TCP encapsulation rule has been received from a network, initiate a fetch of the IPSec information from the IPSec host device upon detection of a first downlink (DL) Security Protocol Index (SPI) over a data path;
upon detecting any new unknown DL SPI, transmit a request to the IPSec host device to provide uplink and downlink SPI (UL/DL SPI); and
receive updated IPSec information comprising the UL/DL SPI from the IPSec host device.

19. The apparatus of claim 18, wherein the processing circuitry is further configured to receive an indication from the IPSec host device immediately upon the IPSec host device creating a new security association (SA) and/or deleting an old SA.

20. The apparatus of claim 18, wherein the processing circuitry is further configured to disable requesting and receiving IPSec information from the IPSec host device when the UE has no valid UDP/TCP encapsulation rules.
